(19) United States
(12) Patent Application Publication
(10) Pub. No.: US 2007/0019617 A1
(43) Pub. Date: Jan. 25, 2007

(54) Method, system and apparatus for maintaining ownership of service calls within an organization

(75) Inventors: Paul E. Hancock, Lago Vista, TX (US); Richard L. Clarke, London (GB); Elizabeth A. Neidel, Austin, TX (US); Lori A. Hawkins, Austin, TX (US); Thomas Burwell, Twin Falls, ID (US); Randall R. Holahan, Leander, TX (US); Kent E. Brenneman, Georgetown, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/172,065

(22) Filed: Jun. 30, 2005

(51) Int. Cl. H04L 12/66

(52) U.S. Cl. 370/352

(57) ABSTRACT

A method, system and apparatus are provided for enabling service technicians to record information about service calls, and have that information available to other technicians who may handle the call at another time. In addition to providing a mechanism for tracking customer information (including product and problem details), the system, apparatus and method disclosed herein enable the transfer of the customer's problems to higher care levels given by different individuals. In order to prevent a problem from being inadvertently dropped, the system, apparatus and method provides an ownership mechanism that allocates the call to a particular individual. If the call needs to be handed off to another individual, a methodology is provided for systematically handing off the call to the other individual (typically at another service level) and ensuring that that individual is responsible for the call from that point forward. Because the customer's problem is tracked, even when transferred to other service technicians, the customer is relieved of the chore of repeating the symptoms of the problem to other service technicians.

### CROSS REFERENCE TO RELATED APPLICATION

This application is related to U.S. patent application Ser. No. ______ [Attorney Docket No. 016295.1930] entitled “Method, System and Apparatus for Tracking Support Calls and Determining Proactive Support Strategies” by Kent Brenneman that was filed on Jun. 30, 2005.

### BACKGROUND

1. Field of the Invention

The present invention relates to control centers. More specifically, the present invention is directed to a system and method for allocating support resources to handle service calls regarding information handling systems.

2 Background of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information processing systems have become more pervasive, they have also become more complex because those systems are tasked more extensively. As a result, failure of the information processing systems can have a significant and deleterious affect on the performance of an organization. As a consequence, companies that manufacture the information processing systems are often asked by their customers to service broken machines.

For years, companies that manufacture information handling systems have strove to provide better customer service, particularly in the event of system failure. Many original equipment manufacturers (“OEM”) use call centers where customers with problems may contact company representatives to obtain solutions to their problems. In many cases, the problem can be resolved with a single telephone call.

In the past, many 1-800 inbound calls were funneled to the same place. When the customer first called in, some logging of the problem took place. However, the key metric for the support agent was to keep the call to less than 15 minutes (in order to keep costs down). Each call—even a repeat call—went to a new person, thereby requiring the support agent to ask the same questions of the customer, and essentially duplicate the same log. This process frustrated customers, and needlessly duplicated work, all without resolving the customer's problem. There is, therefore, a need in the art for a system or method that relieves the customer of the burden of repeating the same troubleshooting information to technicians.

### SUMMARY OF THE INVENTION

The present invention solves the problems inherent in the art by providing a system and method that enables service technicians to record information about service calls, and have that information available to other technicians who may handle the call for one reason or another. In addition to providing a mechanism for tracking customer information (including product and problem details), the system and method disclosed herein enable the transfer of the customer's problems to higher care levels given by different individuals. In order to prevent a problem from being inadvertently dropped, the present invention provides an ownership mechanism that allocates the call to a particular individual. If the call needs to be handed off to another individual, the method disclosed herein provides a methodology for systematically handing off the call to another individual (typically at another service level) and ensuring that that individual is responsible for the call from that point forward. Because the customer's problem (and related information) is tracked, even when transferred to other service technicians, the customer is relieved of the chore of repeating the symptoms of the problem to other service technicians—resulting in higher customer satisfaction.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram of an information handling system according to the teachings of the present invention.

FIG. 2 is a block diagram illustrating a call center servicing remote customers.

FIG. 3 is a flowchart illustrating a inbound agent methodology according to the teachings of the present invention.

FIG. 4 is a flowchart illustrating a service leader methodology according to the teachings of the present invention.

FIG. 5 is a flowchart illustrating a resolution specialist methodology according to the teachings of the present invention.

FIG. 6 is a flowchart illustrating a customer owner (outbound agent) methodology according to the teachings of the present invention.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered.

### DETAILED DESCRIPTION

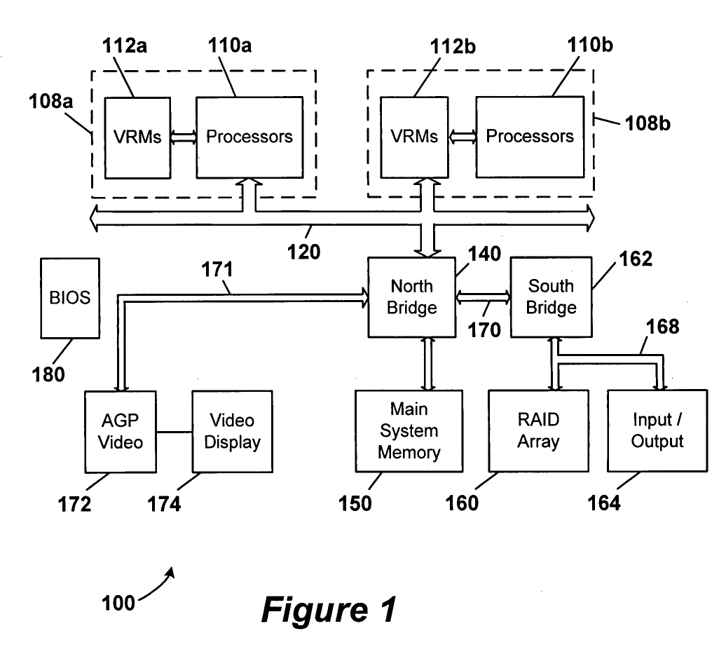

Elements of the present disclosure can be implemented on a computer system, as illustrated in FIG. 1. Referring to FIG. 1, depicted is an information handling system, generally referenced by the numeral 100, having electronic components mounted on at least one printed circuit board (“PCB”) (not shown) and communicating data and control signals there between over signal buses. In one embodiment, the information handling system may be a computer system. The information handling system may be composed processors 110 and associated voltage regulator modules (“VRMs”) 112 configured as processor nodes 108. There may be one or more processor nodes 108, one or more processors 110, and one or more VRMs 112, illustrated in FIG. 1 as nodes 108a and 108b, processors 110a and 110b and VRMs 112a and 112b, respectively. A north bridge 140, which may also be referred to as a “memory controller hub” or a “memory controller,” may be coupled to a main system memory 150. The north bridge 140 may be coupled to the processors 110 via the host bus 120. The north bridge 140 is generally considered an application specific chip set that provides connectivity to various buses, and integrates other system functions such as memory interface. For example, an INTEL® 820E and/or INTEL® 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions, such as main memory control functions, typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The display 174 can be a monitor, or the information to be displayed may be sent to another device, such as a printer (not shown). The second bus may also comprise other industry standard buses or proprietary buses, e.g., ISA, SCSI, USB buses 168 through a south bridge (bus interface) 162. These secondary buses 168 may have their own interfaces and controllers, e.g., RAID Array storage system 160 and input/output interface(s) 164. Finally, a BIOS 180 may be operative with the information handling system 100 as illustrated in FIG. 1. The information handling system 100 can be combined with other like systems to form larger systems. Moreover, the information handling system 100, can be combined with other elements, such as networking elements and or other information handling systems, to form even larger and more complex information handling systems such as, for example, clusters or other enterprise resource planning system, such as an enterprise resource planning portal.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory as described above. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The information handling system described above, or similar systems, may be used to implement the systems and methods described herein. It should be noted that the information handling system needed to implement the methods and systems described herein may be implemented in hardware, in software (in the form of one or more instructions), or in any combination of hardware or software. Moreover, no specific software language is required to implement the systems and methods described herein, and they may be implemented using any desired programming language.

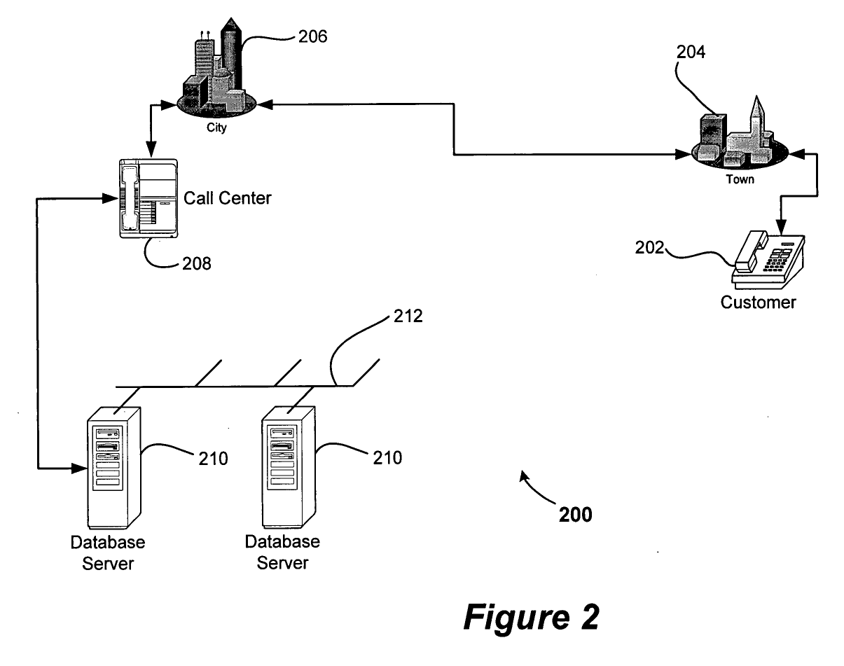

In one embodiment, the manufacturer of a product maintains a call center where customers may call to seek solutions to problems associated with the product. FIG. 2 illustrates an embodiment of the system disclosed herein. Specifically, the system 200 has a customer interface device, such as the telephone 202, although other devices, such as an information handling system could be used with equivalent effect. The customer interface device is connected via a network, such as a telecommunications network, from their place of residence (town 204) to the location of the call center 208 (city 206). The call center 208 houses two or more technicians, typically with disparate skill levels. The call center 208 is operative with a network 212 having one or more database servers 210. The database server 210 contains one or more databases. Each database contains one or more data tables. A database engine, typically executing on the database server 210, is used to receive query requests from the call center 308 and perform the queries on the databases and return the results of the queries to the technicians at the call center 208. The databases can contain, for example, information about the customer's problem, the number of times that that customer has called about the same problem (or different problems) and all calls from all customers about the same, similar, or dissimilar problems. Similarly, the databases can contain information about the customer's product, such as model number, configuration, date of manufacture (of the final product as well as any component contained therein), and any other piece of information retained during the manufacturing process.

In one embodiment, a unique tag, illustratively called a “job number” is created and associated with the specific problem for a particular customer. The customer is given a direct telephone number and/or e-mail address of the OEM service agent and the job number so that the customer can contact that OEM service agent in case additional calls to the call center 208 are needed to resolve the problem associated with the job number. In short, the OEM service agent retains “ownership” of the job number (and the problem) until resolution of the problem is achieved. Callers to the general OEM service number can be prompted for the job number so that the call can be routed immediately to the same service agent who is responsible for that job number. Alternatively, the customer can use the direct telephone numbers and/or email addresses provided during the first contact session. Because the same service agent services all calls related to that problem, and because the service agent can record the particulars of the problem within a database, the customer is relieved from re-describing the problem, and the service agent can progress to a resolution of the problem while still minimizing the duration of the service call. Moreover, pro-active action can be taken if analysis of one or more service calls indicate other customers are likely to encounter the same or a particular problem. In the situation where analysis of past customer problems indicates the likelihood that other customers will be similarly affected, then an account manager or customer service representative may call the customer directly, and propose ways to ameliorate or work around the impending problem.

Alternate embodiments track the number and duration of phone calls, and the type of problem (or type of machine experiencing the problem). Such tracking enables the identification of, for example, bad batches of parts (such as hard disks) or other issues that can be recorded and provided to other service agents who handles calls from other customers experiencing similar problems.

An alternate embodiment provides tracking mechanisms that prompt the service agent to call the customer back in order to determine if the proposed solution (or troubleshooting fixed the customer's problem (a true marketing benefit).

An alternate embodiment provides job numbers that can be given various states, such as “open” when the problem is unresolved and “closed” when resolution is achieved.

Alternate embodiments provide customer tracking that enable the selection of a service agent to a particular customer due to, for example, language needs, time zone requirements, temperament.

Organizations that take advantage of the methods and systems disclosed herein can have an atypical organizational structure and set of procedures for handling service calls. In the past, the following method was employed:
1. Receive an inbound call;
2. Perform a troubleshooting procedure; and
3. Close the call.

In the past, all service personnel performed. essentially the same receive/troubleshoot/close procedure. Unlike the past methodology for handling service calls, the method disclosed herein has, as an example, the following scenario:
1. Receive an inbound call;
2. Perform a troubleshooting procedure;
3. Check to determine if the inbound call or troubleshooting procedure triggered a special handling threshold?
4. If the special handling threshold was passed, then transfer the call to an outbound queue.
5. If the special handling threshold was not passed, then the call is closed.

The methodology disclosed herein requires a new team to service the “outbound queue”. These service representatives are trained to handle more intricate tasks, such as reinstalling the operating system, running extended diagnostics (which may take several hours, and would best be handled with a return phone call after the diagnostics procedure was completed), etc. During the time in the outbound queue, the case is would be marked as “open” and tracked accordingly.

Repeat dispatch events can be analyzed and the analysis results fed back into the system disclosed herein to modify the triggers employed. The modification of triggers can be done manually by, for example, management direction, or the modification of triggers can be made dynamically to respond more rapidly to particular situations. Other triggers, and their sensitivities are possible with the methodology of the present invention.

An important element to the implementation of the method disclosed herein is the size of the team making up the outbound queue. Generally, all teams are similar in overall style. However, the details and triggers handled by the team can vary tremendously. For example, one team can be tasked to handle severe operating system problems. Other teams may specialize in problems related to hard disks or motherboards.

Communications with the customer can be both streamlined and tailored for maximum customer satisfaction. For example, the final email to the customer (normally made when closing out the job) can be auto-generated, thereby conserving resources. Similarly, handing off the case from the initial service agent to the outbound queue team can auto-generate an email to the customer informing both the customer and the outbound queue team of the handoff event.

The progress of any given task (or group of tasks) can be tracked and metrics applied to determine individual or overall performance to ensure quality of service and to prompt management review of methodology in case modification of teams, triggers, or service methods are indicated. The mechanisms used to implement the methodology disclosed herein may be integrated into other methods and mechanisms, such as a parts database, distribution channels, service vendors, and the like.

Non-resolution of the problem by the outbound queue team may prompt a handoff to another specialized team, namely the repeat team, who handle special cases where repeated calls to/from the customer are necessary.

Integration of the method disclosed herein into other mechanisms, methods, networks, and organizations enable the outbound team and repeat teams to handle customer problems in a sensible manner regardless of the time or location of the customer.

In some cases, the trigger may prompt a member of the outbound queue team to call a customer directly (without the customer's prior knowledge). In many cases, this pleases the customer and enables the queue team member to solicit valuable feedback regarding the resolution of the problem that may not have been obtained otherwise.

The above identified methods may be implemented on the information handling system (or groups of systems) illustrated in FIG. 1. Moreover, additional embodiments and implementations are described below, and they too may be implemented on the information handling systems (or group of systems) illustrated in FIG. 1.

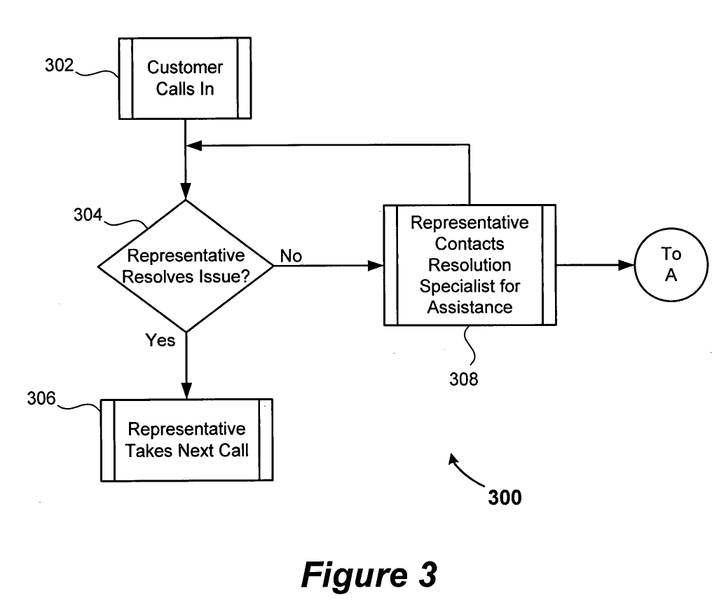

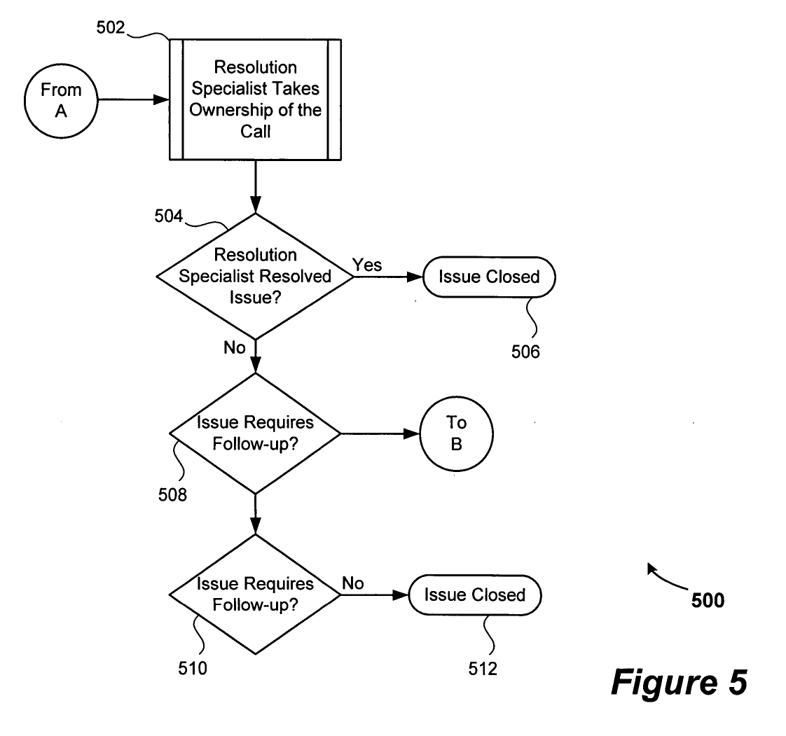

One aspect of an embodiment of the method is illustrated in FIG. 3. The method 300 begins with a call in 302 from a customer to a representative of the OEM. If the representatives was able to resolve 304 the issue with the customer, then the representative simply takes the next customer call 306. Otherwise, if the representative was unable to resolve the issue prompting the call from the customer, then the representative contacts 308 a resolution specialist for assistance. In some cases, the resolution specialist can instruct the representative with the proper way to resolve 304 the issue, otherwise, the resolution specialist takes ownership 502 (see FIG. 5) of the call. Such a handoff can occur, for example, when proper resolution would take too much time for the representative (who could otherwise handle routine customer calls), or if the problem requires a first level of escalation in care.

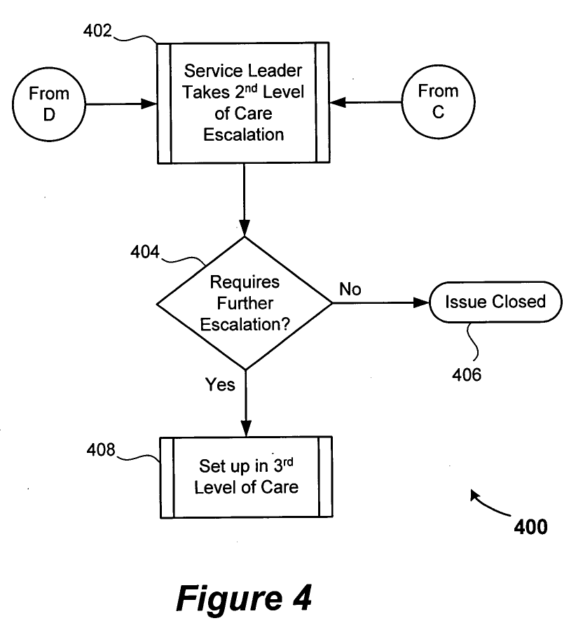

Referring to another aspect of the embodiment of the method 400 in FIG. 4, a service leader (typically a front-line supervisor who oversees the representatives) handles calls that have been taken to the second level of escalated service. The service leader determines 404 if further escalation is required. If not, e.g., the call has been handled properly, then the issue is closed 406. Otherwise, further escalation is warranted and the call is characterized 408 as needing the third level of care, which is typically handled by highly trained specialists.

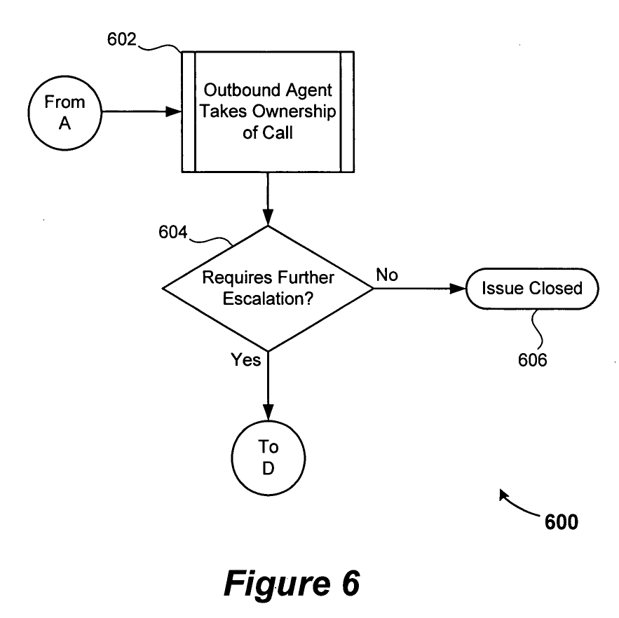

Another aspect of an embodiment of the method is illustrated in FIG. 5. Referring to FIG. 5, the method 500 starts with the resolution specialist taking ownership 502 of the call from the customer. Recall that the intended purpose of the change in ownership is that the customer be placed with a service technician who can take the call and bring the problem to satisfactory resolution for the customer, without the customer having to repeat symptoms or troubleshooting procedures. In some instances, the resolution specialist has the skills necessary to resolve the issue, and ascertains 504, whether or not the call is currently resolved. If so, the issue is closed 506. Otherwise, the resolution specialist may decide 508 whether or not the issue requires a follow-up communication with the customer by, for example, telephone, email, and the like. If additional contact with the customer is deemed necessary, the ownership of the call is transferred to an outbound agent (see FIG. 6). If no follow-up with the customer is necessary at that time, then the resolution specialist determines 510 whether the customer's problem requires yet another escalation in the level of care. If so, the problem is transferred to the service leader (see 402 of FIG. 2). Otherwise, the issue is closed 512, at least as far the resolution specialist is concerned.

Another aspect of an embodiment of the method is illustrated in FIG. 6. Referring to the method 600 of FIG. 6, in the instance where the outbound agent takes ownership 602 of the customer's call from the resolution specialist (see 508 of FIG. 5), the outbound agent determines 604 whether further escalation of the care level for the problem is warranted. If not, the issue is closed 606, at least as far as the outbound agent is concerned. However, if further escalation in the care level is deemed necessary, the service leader is handed the ownership of the call (see 402 of FIG. 4).

In short, the method disclosed herein enables handoff—with attendant ownership—of service calls placed by customers to the organization that handles service calls for the device or system in question. Even if certain problems require one or more higher levels of care, transitioning between individuals within the service organization is streamlined and made systematic and accountable. Providing the various service representatives with database tools, such as access to query the parts database (that lists the parts for a particular machine) and/or service database (which lists the service calls for those particular machines) can empower the various service representatives with the knowledge they need to solve customer problems. Moreover, by storing intermediate information about the particular customer's problem, and the actions taken, the customer is relieved from the chore of repeating the problem to multiple individuals.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A computer-readable medium containing a data structure, comprising:
instructions for receiving information about a problem associated with a customer;
instructions for associating ownership of the problem with a first representative;
instructions for transferring the ownership of the problem from the first representative to a second representative, the second representative having access to the information about the problem.

2. A system for handling one or more problems associated with one or more devices, the system having a call center, the call center capable of receiving one or more calls from one or more customers concerning one or more problems with the one or more devices, the system comprising:
at least one database server associated with the call center, the database server having one or more databases that may be queried by one or more representatives;
an ownership tag associated with each of the one or more problems; and
a representative associated with each ownership tag, the representative retaining ownership of the problem as long as the ownership tag is associated with the representative;
wherein the representative provides service to the customer for the problem associated with the ownership tag.

3. The system of claim 2, wherein the database contains information regarding one or more parts within the one or more devices.

4. The system of claim 2, wherein the database contains information regarding one or more problems associated with the one or more devices.

5. An apparatus for handling one or more problems associated with one or more devices, the apparatus having one or more information handling systems, a call center associated with the one or more information handling systems, the call center capable of receiving one or more calls from one or more customers concerning one or more problems with the one or more devices, the apparatus comprising:
at least one database server operative with the at least one information handling systems, the database server having one or more databases that may be queried by one or more representatives;
an ownership tag associated with each of the one or more problems; and
a representative associated with each ownership tag, the representative retaining ownership of the problem as long as the ownership tag is associated with the representative;
wherein the representative provides service to the customer for the problem associated with the ownership tag.

6. The apparatus of claim 5, wherein the database contains information regarding one or more parts within the one or more devices.

7. The apparatus of claim 5, wherein the database contains information regarding one or more problems associated with the one or more devices.
